(19) United States
(12) Patent Application Publication
(10) Pub. No.: US 2026/0326899 A1
(43) Pub. Date: Oct. 22, 2026

(54) TOILET, AIRCRAFT AND METHOD FOR OPERATING SAME

(71) Applicant: Diehl Aviation Gilching GmbH, Gilching (DE)

(72) Inventors: Bertram Skibinski, Markkleeberg (DE); Hannes Krenz, Dresden (DE); Jan Boris Philipp, München (DE)

(21) Appl. No.: 19/716,217

(22) Filed: Jun. 23, 2026

Related U.S. Application Data
(63) Continuation of application No. PCT/EP2025/054316, filed on Feb. 18, 2025.

(30) Foreign Application Priority Data
Feb. 21, 2024 (DE) 102024104840.9

(51) Int. Cl. B64D 11/02

(52) U.S. Cl. CPC B64D 11/02

(57) ABSTRACT

A toilet has a toilet bowl, a lid for the toilet bowl, a flushing operating element, a flushing input line for flushing water, a wastewater discharge line for wastewater and a control system. The control system of the toilet is configured, during actuation of the flushing operating element, to activate a lowering of the lid onto the toilet bowl before a possible flushing of the toilet bowl with the flushing water can be started. The control system is further configured to determine whether a covered state is present in which the toilet bowl has actually been closed by the lowered lid, and to start flushing if the covered state is determined. Otherwise, the control system determines an error state and initiates an error measure. An aircraft is configured with such a toilet.

### CROSS-REFERENCE TO RELATED APPLICATION

This application is a continuation, under 35 U.S.C. § 120, of copending International Patent Application PCT/EP 2025/054316, filed Feb. 18, 2025, which designated the United States; this application also claims the priority, under 35 U.S.C. § 119, of German Patent Application DE 102024104840.9, filed Feb. 21, 2024; the prior applications are herewith incorporated by reference in their entireties.

### FIELD AND BACKGROUND OF THE INVENTION

The present invention relates to the construction and operation of a toilet, wherein this toilet can in particular also be used for aircraft, and of an aircraft containing the toilet.

Usually, toilets have a toilet bowl which is flushed, upon a corresponding request by the user, by actuating a corresponding flush-operating element. During this flushing, a flushing agent or flushing water is introduced into the toilet bowl and then discharged from the toilet bowl via a wastewater outlet line and in particular extracted by vacuum. The inventors have now found that, when water is injected/introduced into the toilet, aerosols are formed, which can then be inhaled by the user and, if the aerosols are biologically contaminated, can lead to an infection of the user. This circumstance also applies when gray water is used for flushing the toilet.

### SUMMARY OF THE INVENTION

It is therefore the object of the invention to improve a toilet or an aircraft and a corresponding operating method in such a way that the user is not endangered by possible aerosols.

This object is achieved by the subject matter of the invention, which is defined in the independent claims. Some advantageous configurations and developments of the invention are the subject matter of the dependent claims.

With the foregoing and other objects in view there is provided, in accordance with the invention, a toilet containing a toilet bowl, a lid which is lowered onto the toilet bowl in order to close off the toilet bowl, a flush-operating element being actuated by a user of the toilet, a flush inlet line for introducing flushing water into the toilet bowl, a wastewater outlet line for discharging wastewater from the toilet bowl, and a control system. The control system which, upon actuation of the flush-operating element, is configured to first activate a lowering of the lid onto the toilet bowl in order to close off the toilet bowl before a possible flushing of the toilet bowl using the flushing water is started. The control system is further configured to determine whether a covering state, in which the toilet bowl has actually been closed off by the lowered lid, is present and to start the flushing if the covering state is determined. Otherwise, the control system determines a fault state and initiates a fault measure.

The toilet according to the invention contains a toilet bowl; a lid which can be used or is usable to close off or cover the toilet bowl, that is to say can be lowered onto the toilet bowl; a flush-operating element which can be actuated by the user of the toilet; a flush inlet line for introducing a flushing water into the toilet bowl and a wastewater outlet line for discharging wastewater from the toilet bowl. The term “wastewater” is to be understood broadly here and generally includes waste which is located in the toilet bowl and is to be removed therefrom through the wastewater outlet line. This includes, in particular, urine, feces, toilet paper and also flushing water, if this has previously been introduced and is present therein.

The toilet also contains a control system. According to the invention, the control system is configured as follows: When the flush-operating element is actuated, this is understood as a flushing request to the toilet. The lid is thereupon first activated in order to close off the toilet bowl, that is to say it is requested that the lid—if the toilet lid is not yet resting on and covering the toilet bowl—be lowered onto the toilet bowl in order to close or cover it. The request is made before any flushing of the toilet bowl using the flushing water is started. An actual flushing of the toilet bowl can be, but is not necessarily, requested or carried out, as will be explained in more detail further below. This automatic closing off/covering of the toilet bowl by the lid before the flushing is therefore intended to prevent users of the toilet from being exposed to aerosols from the toilet bowl (if the covering has actually taken place). This is because the aerosols are shielded by the lid and can then also be extracted from the toilet bowl by suction, as will be explained in more detail below. This system according to the invention is advantageous also in the case of using gray water for flushing and also in the case of vacuum toilets, which are often used in aircraft.

In other words: In the case of a flushing request due to operation of the flush-operating element, it is first requested that the toilet bowl be covered by the lid. It is then checked whether the toilet lid is actually covering the toilet bowl, i.e. is lowered onto and rests on it, that is to say the covering state has been reached. If so, the toilet is flushed and, in particular, also extracted by suction. If not, the lowering of the lid was not successful and a disturbance in the covering/lowering can thus be assumed. Therefore, a fault state is determined and a fault measure is initiated.

Covering state and fault state cover all possibilities that can occur at the toilet. In other words, at any time/in any state, the toilet can only be either in the covering state or in the fault state.

The control system is thus further configured to determine whether the toilet bowl has actually been closed off/covered by the activated lid. According to the invention, if it has been determined that the toilet bowl is not closed off (fault state), only extraction from the toilet bowl by suction is carried out, in particular without flushing. In other words, if it is determined that the toilet bowl is not closed off, i.e. if it is determined that the toilet lid is not activated so as to cover the toilet bowl, i.e. lowered/placed onto the toilet bowl, then only the contents are extracted from the toilet bowl by suction, in particular by the control system, but without flushing the toilet bowl. In that case, no aerosols are produced by flushing water and any aerosols already existing are extracted by suction.

In other words: First, it is checked whether the toilet lid is now actually/in fact covering the toilet bowl, that is to say is activated, that is to say the covering state is present. If so, the toilet is flushed and, in particular, also extracted by suction. If not, in particular, the flushing is not begun and the toilet bowl is in particular only extracted by suction without being flushed.

In a preferred embodiment, the toilet bowl is configured together with the wastewater outlet line for vacuum extraction of the toilet bowl by suction, in particular of the wastewater out of the toilet bowl. In this case, the toilet thus has a vacuum toilet system. The control system is in this case configured as follows:

Once the covering state has been determined—for the case in which the covering state is present—and the flushing has been started (as explained above), the vacuum extraction by suction is started.

For the other case, in which the fault state is thus present, and once the fault state has been determined, the vacuum extraction by suction is started before a possible flushing in the context of the fault measure. In any case, the fault measure is therefore begun by starting the vacuum extraction by suction, regardless of whether flushing of the toilet bowl also takes place subsequently.

In particular, in the covering state, the flushing is started and then, after a brief pause of, for example, 0.5 s, the extraction by suction is started.

In the fault state, the extraction by suction is started as the first partial measure of the fault measure. In particular, only the extraction vacuum extraction of the toilet bowl by suction by means of the wastewater outlet line takes place without carrying out flushing.

In particular, vacuum extraction by suction is thus always carried out when a flushing request is made. Therefore, “if need be”, aerosols are thus at least also extracted by suction, even if they would not be prevented from exiting the toilet bowl by the lid.

In a preferred embodiment, the control system is configured to bring about the following in the context of the fault measure.

In a first alternative, the toilet is marked as “put out of operation” for further use. This takes place, for example, by means of an appropriate display on or in the vicinity of the toilet, the locking of a toilet door, so that it can no longer be entered, a message to service personnel, who then lock and mark the toilet, etc.

Alternatively or additionally, a flushing operation of the toilet bowl using fresh water as flushing water is started or carried out. The term “fresh water” here is to be understood broadly and means all water in respect of which it can be assumed that—in the case of flushing—it cannot release any aerosols which are harmful to the user of the toilet. This therefore relates to “clean” or “biologically uncontaminated” water, for example also gray water treated in this respect. This ensures that there is no risk posed by aerosols, even if they were to be inhaled.

If the toilet, in the covering state, is flushed for example with gray water, it is possible to switch over to fresh water in the event of a fault, in other words optionally fresh water can be used instead of gray water by way of a switchover.

In a preferred embodiment, the toilet further contains a sensor element which is configured to determine whether there is not only liquid product present in the toilet bowl and to transmit such a determination to the control system. The control system is then further configured as follows: Such a determination is ascertained (and transmitted to the control system) in the context of the fault measure.

If it is determined that there is not only liquid product in the toilet bowl (i.e. also solids, such as toilet paper or feces, for example), the following procedure is adopted: Flushing at reduced pressure and/or with a reduced quantity of the flushing water is carried out: “Reduced” refers in this case to the quantity and pressure of the flushing water during flushing in the covering state. In other words, “gentle flushing” takes place in order to produce fewer aerosols during flushing.

If, on the other hand, it is determined that there is only liquid product in the toilet bowl, for example only urine, the toilet bowl is not flushed.

In particular, the following procedure can be carried out in the event of a fault and upon determination of not only liquid product: In the context of the fault measure, air/aerosol is first extracted from the toilet bowl by suction before flushing takes place. Here, it is optionally possible to wait a short time (e.g. 0.5 s) once the suction has been started before the flushing is started. “Suction” may in this case comprise vacuum extraction by suction, as explained above, but also “gentle suction”, as will be described further below.

In the case of such “gentle flushing”, no aerosols or at least fewer aerosols are then produced by flushing water, and any already existing aerosols are, if necessary, extracted by suction.

In other words, if it is determined that there is not only liquid, but in particular also solid product in the toilet bowl, the following procedure is adopted: First, air/aerosol is extracted from the toilet bowl by suction without flushing water being introduced. Only then, namely after the start of the extraction by suction, is flushing with flushing water started. In this case, however, the flushing water is introduced into the toilet bowl at a lower pressure and/or a smaller amount of flushing water is used per flushing operation. “Lower” and “smaller” refer here to flushing using flushing water in the covering state.

In a preferred embodiment, the toilet further contains an air discharge opening for the additional or separate discharge of air from the region of the toilet bowl. “Separate” means that in this case the air is not extracted by suction in the context of the vacuum extraction by suction explained above, but is extracted by suction in some other way. In a first alternative, this air discharge opening is formed by an air discharge region as a partial region of or in the wastewater outlet line.

Alternatively, the air discharge opening is formed as an auxiliary air discharge opening. This is a separate or additional opening which is not formed by or in the wastewater outlet line.

Through this air discharge opening, air/aerosol or parts can be removed from the toilet bowl without, or without at least significant proportions of, the flushing water/wastewater. As a consequence of this, the flushing of the toilet bowl—with in particular simultaneous extraction of air and possibly aerosols therefrom by suction—subsequently can be performed in a manner that is less hazardous for the user.

The control system is therefore configured as now described. In the context of the fault measure, the discharge of air through the air discharge opening is first started, and only then is flushing of the toilet bowl started.

In other words, an additional or preliminary extraction by suction (optionally before a subsequent vacuum extraction by suction) takes place with a lower flow (lighter air flow before/during the flushing compared with a flow during vacuum extraction by suction). Optionally, the air flow is intensified in the form of alternative or additional vacuum extraction by suction during or after the flushing (rinsing).

In a preferred variant of this embodiment, the air discharge region is created by the wastewater outlet line containing a disk valve. The latter has a first opening which serves for vacuum extraction by suction and a second opening in the form of the air discharge opening. The disk valve is further configured such that by rotating the disk valve, in a first rotary position the wastewater outlet line is shut off, in a second rotary position the wastewater outlet line is opened exclusively by way of the air discharge opening, and in a third rotary position the wastewater outlet line—as an alternative or in addition to the air discharge opening—is opened by way of the first opening.

The described toilet according to the invention can in particular also be used in aircraft. The toilet according to the invention used in the aircraft can then in particular also be connected to a vacuum toilet system.

In other words, the invention thus also relates to an aircraft having a toilet according to the invention, as described above.

The aircraft and at least some of the possible embodiments thereof and the respective advantages have already been explained analogously in connection with the toilet according to the invention. In particular, this means that the preferred embodiments mentioned above in connection with the toilet also form preferred embodiments of the aircraft.

In a preferred embodiment, the toilet is connected to a vacuum toilet system which is also a component of the aircraft.

The invention also relates to a corresponding method for operating a toilet, in particular the toilet according to the invention described above, or an aircraft containing the toilet, in particular the aircraft according to the invention.

In the method, the following procedure is adopted whenever a flushing request for flushing a toilet bowl of the toilet using a flushing water is detected. A flushing request is in this case in particular the actuation of a flush-operating element of the toilet by a user of the toilet.

A lid of the toilet is first activated in order to close off the toilet bowl, i.e. it is requested that the lid be lowered onto the toilet bowl so as to cover/close the latter (if the lid is not yet activated/lowered) before a possible flushing of the toilet bowl is started. This achieves the same advantages as have already been explained above with respect to the toilet according to the invention.

In the method, it is further determined whether—in response to the request for lowering of the lid—a covering state of the toilet or toilet bowl has actually been reached or is present; that is to say whether, in the covering state, the toilet bowl has actually been closed off by the activated/lowered lid. Whenever the covering state has been determined, the flushing is started. Otherwise, a fault state is determined and a fault measure is initiated. In particular, in the fault state, only extraction from the toilet bowl by suction is carried out without flushing, that is to say if it has been determined that the toilet bowl is not closed off.

The method and at least some of the possible embodiments thereof and the respective advantages have already been explained analogously in connection with the toilet according to the invention and the aircraft according to the invention. In particular, this means that the preferred embodiments mentioned above in connection with the toilet and the aircraft also form preferred embodiments of the method.

In a preferred embodiment, if the toilet bowl is designed together with a wastewater outlet line of the toilet for vacuum extraction of the toilet bowl by suction, the following procedure is adopted. If the covering state has been determined and once the covering state has been determined and once the flushing has been started, the vacuum extraction by suction is started. Alternatively, if, by contrast, the fault state has been determined and once the fault state has been determined, the vacuum extraction by suction is started before a possible flushing in the context of the fault measure.

In a preferred embodiment, the following procedure is adopted in the context of the fault measure. The toilet is marked as “put out of operation” for further use and/or the flushing operation of the toilet bowl is started using fresh water as flushing water.

In a preferred embodiment, it is further determined in the context of the fault measure whether there is not only liquid product present in the toilet bowl. If it has been ascertained that there is not only liquid product in the toilet bowl, then flushing is carried out using flushing water of reduced pressure and/or reduced quantity compared with the covering state.

Alternatively or additionally, the following measure is taken, if it has been ascertained that there is only liquid product in the toilet bowl, then the toilet bowl is not flushed.

A preferred embodiment of the method applies to a toilet which further comprises an air discharge opening for the additional discharge of air from the region of the toilet bowl. In this case and in this embodiment, the method is performed as follows: In the context of the fault measure, first the separate discharge of air from the toilet bowl through the air discharge opening of the toilet at a lower flow rate (lower than a vacuum extraction by suction through the wastewater outlet line) is started. Only then is flushing of the toilet bowl started.

In other words, in the event of a flushing request, first the air extraction by suction is activated without previously starting a flushing operation. The flushing of the toilet bowl is then started only at the same time as the air extraction by suction or with a time delay after the start thereof.

In a preferred embodiment, gray water is used, at least in the covering state, for flushing the toilet.

In a preferred embodiment, the extraction from the toilet bowl of the toilet by suction is carried out by means of a vacuum toilet system.

The invention is based on the following findings, observations or considerations and has furthermore the following preferred embodiments. These embodiments are also sometimes referred to as “the invention” for the sake of simplicity. The embodiments may in this case also contain parts or combinations of the aforementioned embodiments or correspond to them and/or possibly also include embodiments which have not yet been mentioned.

According to the invention, the result is an aerosol-safe toilet. In particular, an automatic toilet lid (intended to close automatically before flushing) is proposed for shielding aerosols when using gray water for flushing in vacuum toilets, and measures (fault measure(s)) are specified for safe operation in the event of a fault.

The invention is also in the field of a gray water system for aircraft. The aim is in particular the—possibly improved—reuse of gray water in the aircraft.

The invention is based on the following findings where in the area of a toilet, the following challenges arise, namely, when water is injected into a toilet, aerosols are formed. These aerosols can be inhaled and, if the aerosols are biologically contaminated, lead to an infection of the user. When using gray water for flushing, therefore, either the water can be treated in such a way that it is not contaminated, or inhalation of the aerosols should be prevented.

The basic idea of the invention is therefore the following: An “automatic toilet lid” is to be created for shielding aerosols when using gray water for flushing the toilet bowl. “Automatic” means that, in a fault-free case, the lid should first lower onto the toilet bowl in order to close it before flushing (in particular using gray water) is carried out.

In this case, the following sequence is proposed in particular: A flush button (flush-operating element) is actuated; the lid closes automatically; the lid status is reported (ascertainment of whether the covering state or the fault state is present); flushing water is injected (but in particular only if the covering state is present). Optionally, in the case of vacuum toilets, vacuum extraction of the toilet bowl by suction can take place in the course of the flushing.

As a result, the aerosol exposure of a user of the toilet during flushing is prevented/reduced. Vacuum toilets have the following further advantage: Aerosols in the toilet bowl and under the lid are suction extracted by the vacuum and cannot diffuse out.

However, a malfunction (presence of the fault state) is a problem. In other words, how to handle a situation in which the toilet lid does not close or does not close correctly, i.e. the toilet bowl is not covered or not sufficiently covered by the lid, so that—in the case of regular flushing as in the covering state—aerosols could nevertheless escape.
1). The operation could stop. The consequence of this is that the toilet is “defective”. This is very critical as a toilet failure has major impacts.
2.) Use of clean water (fresh water) for flushing. This solution is possible if a water source (provision/supply/source of the flushing water) can be changed (gray water as flushing water in the covering state and fresh water in the fault state) automatically (between the covering state and the fault state) and sufficient clean water is present. However, this solution does not appear possible in mobile applications (aircraft/rail vehicle) in which the amount of water is limited if the toilet lid permanently does not close (ongoing fault state).
3.) Optimized flushing and extraction by suction in vacuum toilet systems. In this case, the formation of aerosol can be reduced by the following measures, which can be combined.
a1) Always extracting by suction without flushing. The disadvantage here is that this results in contamination of the toilet bowl.
a2)Extracting by suction without flushing only if there is only liquid product (e.g. urine) in the toilet bowl. In this case, a sensor (sensor element) is required for identifying the state (“only liquid product” or “not only liquid product”).
b) Reducing the amount of water and/or the water pressure during the flushing operation. In this way, a partial cleaning of the toilet bowl is nevertheless carried out.
c1)Starting the extraction by suction before the start of the flushing (e.g. 0.5 s) in order to thus generate an air flow which pulls the aerosols away from the user. This results in an only slightly worse cleaning effect.
c2) Preliminary extraction by suction with a lower flow (compared with vacuum extraction by suction) before the start of the flushing in order to generate an air flow which pulls the aerosols away from the user. This results in an only insignificantly worse cleaning effect.

With regard to the aforementioned preliminary suction by extraction with a lower flow before the start of the flushing, the following should also be noted. It is proposed to start the extraction by suction before the start of the flushing (e.g. 0.5 s) in order to generate an air flow which pulls the aerosols away from the user. This results in only a slightly worse cleaning effect (since, for example, toilet paper has not yet been completely moistened).

The following solution is conceivable:

Establishing a lighter air flow before/during rinsing (flushing) in order to prevent the spread of aerosols.

Strengthening the air flow after the rinse operation (flushing) in order to completely remove solids and, for example, soaked toilet paper.

As a result, aerosols can be removed at an early stage, combined with a good cleaning effect with minimal throughput of air.

In order to realize a supply line of a vacuum for the extraction by suction with reduced flow, there are in particular the following possibilities:
1.) Insertion of a disk valve in the wastewater outlet line. Air can then be extracted in the region of a free opening height of the previous opening of the wastewater outlet line in order to avoid blockage. In a first valve position, the wastewater outlet line is closed. In a second valve position, the air extraction (reduced flow) takes place during the water flushing. In a third valve position, vacuum extraction by suction (“flushing”) takes place.

In particular, this involves creating an additional opening in the disk valve.
2.) Use of a conventional disk valve in the vacuum supply line (wastewater outlet line), i.e. two valve positions: Wastewater outlet line closed or completely open (flush/vacuum extraction by suction). Additional creation of a separate air extractor (that is to say not in the wastewater outlet line) in the region of or by way of a new additional air duct in the form of the air discharge opening (this results in a lower risk of blockage when extracting air during rinsing (flushing)). Starting from a closed wastewater outlet line and no extraction by suction through the air discharge opening, extraction by suction then first takes place through the air discharge opening, with the wastewater outlet line remaining closed. The flushing/vacuum extraction by suction then takes place through the wastewater outlet line without extraction by suction through the air discharge opening.

The invention is defined by the appended claims. The elucidated exemplary embodiments serve only for a better understanding of the invention and are not intended to limit the scope of protection defined by the claims. As will be apparent to those skilled in the art, yet further embodiments are also possible within the scope of the invention, in particular by adding additional features to the described exemplary embodiments and by combinations of features from the described exemplary embodiments that are not explicitly mentioned.

Other features which are considered as characteristic for the invention are set forth in the appended claims.

Although the invention is illustrated and described herein as embodied in a toilet, an aircraft and a method for operating same, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is an illustration of a toilet according to the invention;

FIG. 2 is an illustration showing the toilet from FIG. 1 in an alternative embodiment without auxiliary air discharge opening during operation in the case of vacuum extraction by suction with prior extraction by suction at a lower flow rate;

FIG. 3A is an illustration showing a first variant of a disk valve in the toilet according to FIG. 2 in rotational positions for the operation according to FIG. 2;

FIG. 3B is an illustration showing a second variant of the disk valve in the toilet according to FIG. 2 in rotational positions for the operation according to FIG. 2;

FIG. 4 is an illustration showing the toilet from FIG. 1 in an illustration according to FIG. 2;

FIG. 5 is a flow diagram of a method for operating the toilets of FIGS. 1 to 4; and

FIG. 6 is a graph showing a profile of control signals for the toilet from FIG. 2 over time during a flushing operation.

### DETAILED DESCRIPTION OF THE INVENTION

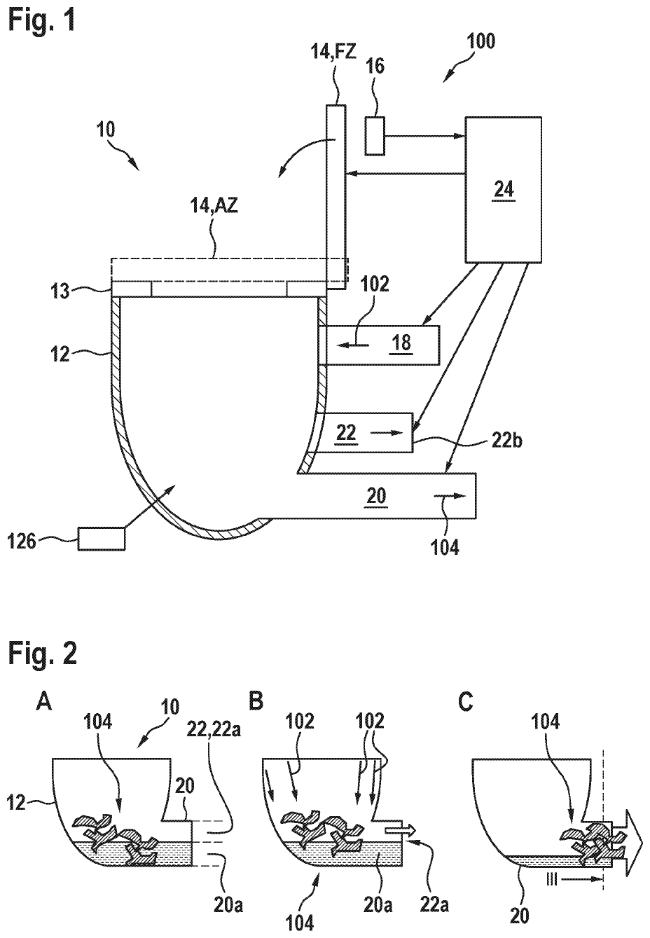

Referring now to the figures of the drawings in detail and first, particularly to FIG. 1 thereof, there is shown a toilet 10 of a toilet system, with some customary elements of such toilets 10. Toilet systems and elements to which the toilet 10 can be connected and elements in which the toilet 10 can be incorporated are not illustrated in FIG. 1. The toilet 10 is in this case arranged in a cabin (not illustrated in detail) of an aircraft 100 (not illustrated in detail), and gray water is usually used for flushing the toilet, as will be explained further below.

The toilet 10 has, analogously to conventional toilets, a toilet bowl 12, on the top side of which there is a toilet seat 13 for sitting and a lid 14 for closing off/covering the toilet bowl 12. The toilet seat 13 and the lid 14 are can each be rotated between a first position (lowered position) on the top side of the toilet bowl 12 (illustrated in FIG. 1 by a solid line for the toilet seat 13 and by a dashed line for the lid 14) and an open position (illustrated in FIG. 1 by a solid line for the cover 14). When the lid 14 is in the lowered position, it shields the toilet bowl 12 and thus aerosols formed therein in the toilet 10 from the surroundings of the toilet 10 and thus from a toilet user (not illustrated). This position of the lid 10 therefore describes the covering state AZ thereof and is illustrated by dashed lines in FIG. 1.

Analogously to conventional toilets, the toilet 10 contains a flush-operating element 16 which can be actuated by the toilet user, a flush inlet line 18 for introducing a flushing water 102 (symbolized by an arrow) into the toilet bowl 12, and a wastewater outlet line 20 for discharging wastewater 104 (symbolized by an arrow) from the toilet bowl 12. During vacuum extraction by suction, in addition to the wastewater 104, air/aerosol is also extracted from the toilet 10/toilet bowl 12 by suction through the wastewater outlet line 20 (see FIGS. 2 and 4).

In the exemplary embodiment according to FIG. 1, the toilet 10 also contains an additional air discharge opening 22 in the form of an auxiliary air discharge opening 22b for the additional discharge of air/aerosol from the toilet bowl 12. “Additional” means an alternative outlet for air/aerosol to that which leads out of the toilet 10 via the wastewater outlet line 20.

Contrary to the exemplary basic structure of the toilet shown in FIG. 1, however, the air discharge opening 22 does not necessarily have to directly abut the toilet bowl 12 and can be designed for example (not illustrated in the figures) as an extra line in the region around the toilet bowl 12.

In addition, the toilet 10 contains a control system 24 which is coupled to the flush-operating element 16, the lid 14 of the toilet bowl 12, the flush inlet line 18, the wastewater outlet line 20 and the air discharge opening 22.

The control system 24 is configured such that, upon actuation of the flush-operating element 16, it first activates the lid 14 in order to lower it onto the toilet bowl 12. In other words, it is requested that the lid 14 reaches the covering state AZ in order to close off/cover the toilet bowl 12 before flushing (flushing water 102) of the toilet bowl 12 through the flush inlet line 18 is started.

In other words, the control system 24 is configured such that, upon actuation of the flush-operating element 16, it first activates a lowering of the lid 14 onto the toilet bowl 12 in order to close off the toilet bowl 12 before a possible flushing of the toilet bowl 12 using the flushing water 16 is started. The control system 24 is further configured to determine whether the covering state AZ is actually present, that is to say the request was successful. It is thus ascertained whether the toilet bowl 12 has actually been closed off by the lowered lid 14. The flushing is started if the covering state AZ is determined. Otherwise, a fault state FZ is to be determined and a fault measure FM is initiated. This is explained further below.

FIG. 2 shows an exemplary embodiment of the toilet 10. In this case, the air discharge opening 22 is not in the form of a separate auxiliary air discharge opening 22b. Instead, it is in the form of an air discharge region 22a of the waste water outlet line 20 itself. The wastewater outlet line 20 connected to the toilet bowl 12 therefore has a wastewater discharge region 20a—at the bottom in FIG. 2—and the air discharge region 22a at the top.

FIG. 2 shows the toilet 10 after use. Liquid product in the form of urine and solid product in the form of toilet paper are now present in the toilet bowl 12 as wastewater 104. In the position “A” shown on the left in FIG. 2, the wastewater outlet line 20 is still closed. There is no discharge of wastewater 104 or air/aerosol from the toilet bowl 12.

In the position “B” shown in the center, the wastewater discharge region 20 a of the wastewater outlet line 20 is still closed, such that vacuum extraction by suction of the wastewater 104 from the toilet bowl 12 is not yet taking place. However, the air discharge region 22a of the wastewater outlet line 20 is already open, such that air and any aerosol present are extracted from the toilet bowl 12 by suction. The introduction of flushing water 102, indicated by arrows, then starts. This results or can result in (further) aerosols. These, too, are at least partially extracted by suction via the air discharge region 22a. The toilet user standing next to the toilet 10 is therefore protected from inhaling the aerosols.

In the position “C” shown on the right in FIG. 2, which in an alternative embodiment can also directly follow the position “A”, the wastewater discharge region 20 a (and the air discharge region 22 a) of the wastewater outlet line 20 is open, such that “normal” vacuum extraction of the toilet bowl 12 by suction then takes place via the entire wastewater outlet line 20. Both the wastewater 104 and —at an increased suction force/flow rate compared with position B—air and aerosol are in this case extracted from the toilet bowl 12 by suction.

The flushing of the toilet (flushing water 102 arrows) can be carried out using fresh or gray water. The lid 14 is not closed in FIG. 2. The aerosols are thus extracted by suction when the toilet lid 14 is not closed for the purpose of aerosol reduction after the start of the aerosol extraction by suction (position “B” or, if this is not present, position “C”).

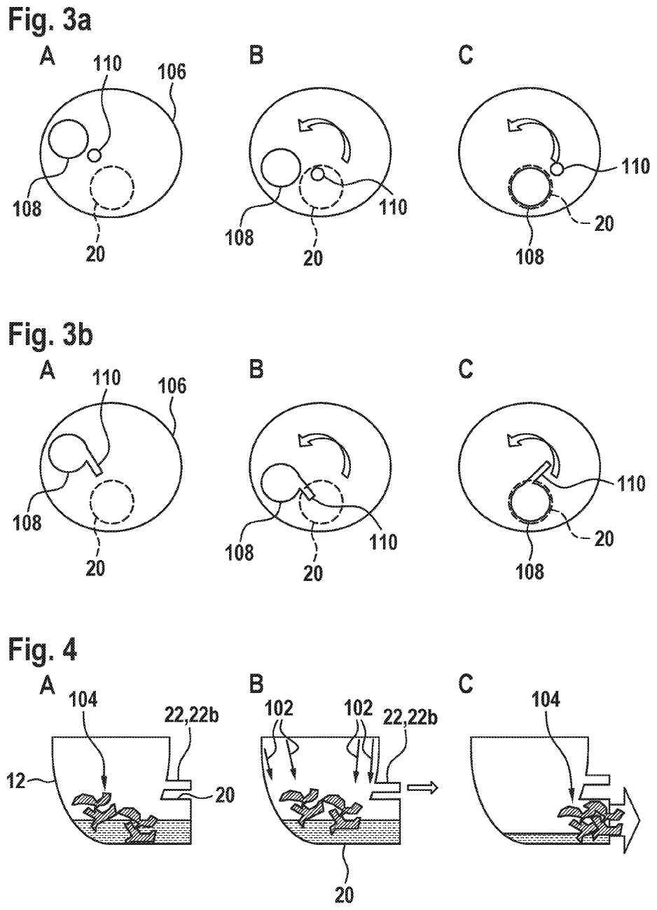

FIG. 3A shows a cross section along the line III from FIG. 2 through the toilet 10 or the wastewater outlet line 20. A disk valve 106 is located on the latter and extends over the entire cross section of the wastewater outlet line 20 and beyond and is rotatable (arrows in positions B and C). The rotational positions in positions A-C, as described above, are shown. The disk valve 106 contains a first opening 108 which can open up the entire cross section of the wastewater outlet line 20 in order to carry out a vacuum extraction by suction. The disk valve contains a second opening 110 which can open up only a partial region of the cross section of the wastewater outlet line 20, which partial region is located above the water level of the wastewater 104 in FIG. 2, in order to allow separate discharge/extraction by suction of air/aerosol from the toilet bowl 12 via the wastewater outlet line 20, without wastewater 104 being able to flow off.

In position A, the wastewater outlet line 20 is completely shut off by way of a solid portion of the disk valve 106. In position B, the second opening 110 is rotated into the wastewater outlet line 20, such that the separate discharge/extraction by suction of air/aerosol from the toilet bowl 12 takes place. In position C, the first opening 108 is rotated into the wastewater outlet line 20, such that the vacuum extraction by suction of air/aerosol and wastewater 104 from the toilet bowl 12 takes place.

FIG. 3B shows an alternative disk valve 106. Here, the first opening 108 and the second opening 110 are in the form of two portions of an overall opening. Otherwise, the statements regarding FIG. 3A also apply analogously here.

The disk valves 106 of FIGS. 3A and 3B thus show further variants for realizing the air discharge opening 22 in the form of the air discharge region 22a, in which an additional opening in the form of the air discharge opening 22, which is formed in the wastewater outlet line 20, is present in each case in the toilet bowl 12.

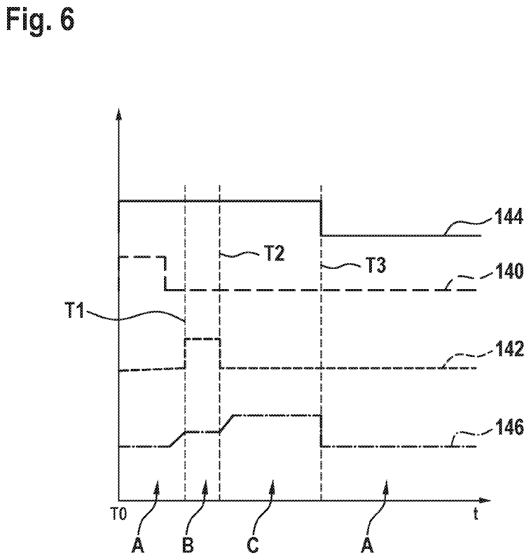

FIG. 6 shows a sequence of control signals for the toilet 10 from FIG. 2 or the positions A to C shown therein over time t. At the time T0, the toilet 10 is initially in the position A once a user has used it. At the time T0, the user actuates the flush-operating element. A lid signal 140 is a closing signal for the lid 14. However, this is blocked and does not close. The fault state FZ is therefore identified. The disk valve is in position A. This is indicated by the valve signal 146 (in this case rotational position according to position A). Vacuum generation at the wastewater outlet line 20 is started at the time T0, as shown by the vacuum signal 144. Negative pressure prevails at the disk valve but does not affect the toilet bowl 12 on account of the closed position of the disk valve.

At the time T1, therefore, a flushing signal 142 becomes active, which triggers the introduction of the flushing agent 102, as shown in position B. To this end, the disk valve 106 transitions into the rotational position according to position B (evident from the valve signal 146). Air and aerosol are extracted from the toilet bowl 12 by suction on account of the vacuum which then acts in the toilet bowl 12 by way of the wastewater outlet line 20 due to the second opening 110. The flow of the air extraction by suction is reduced owing to the comparatively small second opening 110.

At the time T2, the introduction of the flushing water is terminated (flushing signal 142 becomes inactive). The disk valve 106 transitions into the rotational position according to position C (fully open due to first opening 108), as is evident from the valve signal 146. The vacuum extraction by suction then takes place with full vacuum pressure and full flow of the air extraction by suction.

At the time T3, the vacuum extraction by suction is terminated. The vacuum is released/deactivated (vacuum signal 144). At the same time, the rotary valve returns to position A according to valve signal 146 and the wastewater outlet line 20 is closed again.

FIG. 4 shows the exemplary embodiment of the toilet 10 from FIG. 1. Here, an additional air discharge opening 22 of the toilet 10 is formed as an auxiliary air discharge opening 22 b separate from the wastewater outlet line 20. In other words, the air discharge opening 22 is thus formed here by an auxiliary air discharge opening 22 b separate from the wastewater outlet line 20.

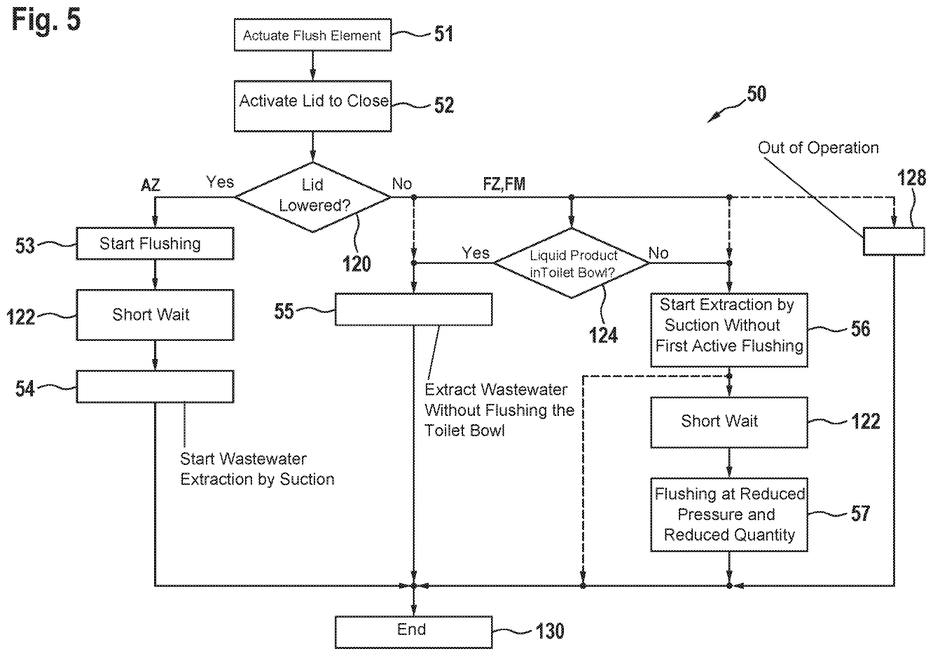

FIG. 5 illustrates a method 50 according to which the toilet 10 is operated.

In a step 51, the flush-operating element 16 is actuated by the toilet user.

A flushing request to the toilet 10 is therefore detected.

In a step 52 (closing the toilet bowl 12 by means of lid 14), the lid 14 is activated—after the detected flushing request—in order to close off the toilet bowl 12. That is to say, a drive (not illustrated) is activated in order to lower the lid 14 onto the toilet bowl 12 if the lid has not yet been lowered into the covering state AZ.

In a step 120, a check is then performed as to whether the request for activation/lowering of the lid 14 has actually resulted in success. It is thus checked whether the covering state AZ is actually present, that is to say the toilet bowl 12 is actually closed off by the lid 14.

In the event that the covering state AZ is actually present (“Y” in FIG. 5), the flushing of the toilet bowl 12 is started in a step 53 (starting the flushing when toilet bowl 12 closed). This is effected by opening the flush inlet line 18 and thus introducing flushing water 102 into the toilet bowl 12.

In a step 122, there is a short wait after the start of the flushing, in this case 1 second.

In a step 54 (extracting wastewater by suction—preferably by means of a vacuum system), that is to say after the short pause (step 122), the wastewater extraction by suction is then started. The wastewater outlet line 20 is opened and, with the aid of a vacuum system (not illustrated) of the aircraft 100, is subjected to a comparatively strong vacuum in comparison with the abovementioned discharge of air via the air discharge opening 20. Wastewater 104 and air/aerosols are thus discharged from the toilet bowl 12.

This terminates the method (end 130).

If it is determined in step 120 that—in a faulty manner—the lowering of the lid 14 was not successful, that is to say the covering state AZ has not occurred, the fault state FZ is determined (“N” in FIG. 5). The toilet bowl 12 is thus not closed off by the lid 14. A fault measure FM is therefore initiated. There are multiple options for this.

In one embodiment, the toilet 12 contains a sensor element 126 (see FIG. 1). The latter is able to determine whether there is only liquid product in the form of wastewater 104 (here only water and urine) in the toilet bowl or whether there is not only liquid but also solid product in the form of wastewater 104 (here urine and water and toilet paper) in the toilet bowl.

In a step 124—in this case with the aid of the sensor element 126—it is ascertained whether there is wastewater 104 in the form of only a liquid product in the toilet bowl 12.

If this is the case (“Y” in FIG. 5), the wastewater 104 is extracted by suction (for example by means of a vacuum system, as explained above) in a step 55 without flushing the toilet bowl 12 in the process. There is thus no introduction of flushing water 102. Step 55 thus describes “extracting by suction (preferably by means of a vacuum system) without flushing when toilet bowl 12 is not closed, if only liquid product is present”.

However, if there is not only liquid product present in the toilet bowl 12 (“N” in FIG. 5), the extraction by suction is started (for example by means of a vacuum system) in step 56 without first activating flushing. In a step 122, there is also a brief wait here, of 0.5 second in the example. Only then, that is to say after a short pause (step 122), is flushing at reduced (for example reduced by 25%) pressure and reduced quantity (for example 25%) of the flushing water 102 carried out in a step 57. This is thus effected only after the start of the extraction by suction in step 56. This also terminates the method.

Step 56 therefore describes “starting the extraction by suction (preferably by means of a vacuum system) without flushing when toilet bowl 12 is not closed, if there is not only liquid product present”.

Step 57 therefore describes “flushing at reduced pressure and reduced quantity”.

Alternatively, however, in this case, after the execution of step 56, the two following steps are bypassed, that is to say not carried out (illustrated by dashed lines in FIG. 5). Thus, only vacuum extraction by suction takes place without flushing.

Alternatively, however, it is not the vacuum extraction by suction that is started in step 56, but rather only a preliminary extraction by suction. This means that, by means of the air discharge opening 22, air and possibly aerosol is extracted from the toilet bowl by suction. Steps 122 and 57 are then carried out as described above; in step 57, however, vacuum extraction by suction is then additionally started.

The two sequences in the paths illustrated in FIG. 5 with step 55 on the one hand and steps 56 (and possibly 122 and 57) on the other hand can also take place without the query in step 124. As an emergency measure, either the path on the left in FIG. 5 (step 55) or the path on the right (step 56, optionally also 122 and 57) is thus carried out directly.

As a further option for a fault measure FM, a step 128 can also be carried out. In this step, in various embodiments: either the toilet 10 is marked as “put out of operation” for further use; and/or a flushing operation of the toilet bowl 12 using fresh water as flushing water 102 is started in accordance with steps 53, 122 and 54 (left-hand path in FIG. 5). In this case, the supply of the flushing water 102 to the flush input line in the aircraft 100 is optionally switched over from a gray water source to a fresh water source (neither is illustrated in the figures).

The following is a summary list of reference numerals and the corresponding structure used in the above description of the invention:
10 toilet
12 toilet bowl
13 toilet seat
14 lid
16 flush-operating element
18 flush inlet line
20 wastewater outlet line
20a wastewater discharge region
22 air discharge opening
22a air discharge region
22b auxiliary air discharge opening
24 control system
50 method
51 step
52 step
53 step
54 step
55 step
56 step
57 step
100 aircraft
102 flushing water
104 wastewater
106 disk valve
108 first opening
110 second opening
120 step
122 step
124 step
126 sensor element
128 step
130 end
140 lid signal
142 flush signal
144 vacuum signal
146 valve signal
AZ covering state
FZ fault state
A, B, C position
FM fault measure

1. A toilet, comprising:
a toilet bowl;
a lid which is lowered onto said toilet bowl in order to close off said toilet bowl;
a flush-operating element being actuated by a user of the toilet;
a flush inlet line for introducing flushing water into said toilet bowl;
a wastewater outlet line for discharging wastewater from said toilet bowl; and
a control system which, upon actuation of said flush-operating element, is configured to first activate a lowering of said lid onto said toilet bowl in order to close off said toilet bowl before a possible flushing of said toilet bowl using the flushing water is started, wherein said control system is further configured to determine whether a covering state, in which said toilet bowl has actually been closed off by said lowered lid, is present and to start the flushing if the covering state is determined, and otherwise to determine a fault state and to initiate a fault measure.

2. The toilet according to claim 1, wherein said toilet bowl is configured together with said wastewater outlet line for vacuum extraction of said toilet bowl by suction, wherein said control system is further configured to:
once the covering state has been determined and the flushing has been started, to start the vacuum extraction by suction; and
once the fault state has been determined, to start the vacuum extraction by suction before a possible flushing in a context of the fault measure.

3. The toilet according to claim 1, wherein said control system is configured to, in a context of the fault measure to:
characterize the toilet as put out of operation for further use; and/or
start a flushing operation of said toilet bowl using fresh water as the flushing water.

4. The toilet according to claim 1,
further comprising a sensor element configured to determine whether there is only or not only liquid product present in said toilet bowl;
wherein said control system is configured to:
ascertain such a determination in a context of the fault measure; and
flush using the flushing water of reduced pressure and/or reduced quantity compared with the covering state when it has been ascertained that there is not only the liquid product in said toilet bowl; and/or
not to flush said toilet bowl when it has been ascertained that there is only the liquid product in the toilet bowl.

5. The toilet according to claim 1,
further comprising an air discharge opening for a separate discharge of air from a region of said toilet bowl, said air discharge opening is formed by an air discharge region as a partial region of said wastewater outlet line or an auxiliary air discharge opening separately from said wastewater outlet line;
wherein said air discharge opening is configured for extraction of said toilet bowl by suction at a lower flow rate compared with a vacuum extraction by suction through said wastewater outlet line; and
wherein said control system is configured, in a context of the fault measure, to first start a discharge of the air through said air discharge opening and only then to start flushing of said toilet bowl.

6. The toilet according to claim 5, wherein said air discharge region is created by said wastewater outlet line containing a disk valve which has a first opening formed therein for the vacuum extraction by suction and a second opening formed therein in a form of said air discharge opening as said air discharge region, wherein, by rotating said disk valve:
either said wastewater outlet line is shut off or is opened exclusively by way of said second opening or is opened by way of said first opening.

7. An aircraft, comprising:
said toilet according to claim 1.

8. The aircraft according to claim 7, further comprising a vacuum toilet system, wherein said toilet is connected to said vacuum toilet system of the aircraft.

9. A method for operating a toilet or an aircraft containing the toilet, which comprises the steps of:
detecting a flushing request for flushing a toilet bowl of the toilet using flushing water;
activating a lid in order to close off the toilet bowl before the flushing of the toilet bowl is started; and
ascertaining whether a covering state, in which the toilet bowl has actually been closed off by a lowered lid, is present and, whenever the covering state has been determined, the flushing is started and otherwise a fault state is determined and a fault measure is initiated.

10. The method according to claim 9, wherein the toilet bowl is configured together with a wastewater outlet line of the toilet for vacuum extraction of the toilet bowl by suction:
starting the vacuum extraction by suction when and once the covering state has been determined; and
starting the vacuum extraction by suction before the flushing in a context of the fault measure when and once the fault state has been determined.

11. The method according to claim 10, wherein in the context of the fault measure:
marking the toilet as put out of operation for further use; and/or
starting a flushing operation of the toilet bowl using fresh water as the flushing water.

12. The method according to claim 10, which further comprises determining in the context of the fault measure whether there is not only liquid product present in the toilet bowl, wherein:
when it has been ascertained that there is not only the liquid product in the toilet bowl, flushing is carried out using the flushing water of reduced pressure and/or reduced quantity compared with the covering state; and/or
the toilet bowl is not flushed when it has been ascertained that there is only the liquid product in the toilet bowl.

13. The method according to claim 10, wherein in the context of the fault measure:
starting first a separate discharge of air from the toilet bowl through an air discharge opening of the toilet at a lower flow rate compared with a vacuum extraction by suction through the wastewater outlet line; and
only then is the flushing of the toilet bowl started.

14. The method according to claim 9, which further comprises using gray water as the flushing water, at least in the covering state, for the flushing of the toilet.

15. The method according to claim 10, which further comprises carrying out the vacuum extraction from the toilet bowl of the toilet by suction by means of a vacuum toilet system.
